(19) United States
(12) Patent Application Publication
(10) Pub. No.: US 2024/0034625 A1
(43) Pub. Date: Feb. 1, 2024

(54) NANOSCALE IRON PHOSPHATE, PREPARATION METHOD THEREFOR AND USE THEREOF

(71) Applicants: GUANGDONG BRUNP RECYCLING TECHNOLOGY CO., LTD., Foshan, Guangdong (CN); HUNAN BRUNP RECYCLING TECHNOLOGY CO., LTD., Changsha,Hunan (CN); HUNAN BRUNP VEHICLES RECYCLING CO., LTD., Changsha, Hunan (CN)

(72) Inventors: Haijun YU, Foshan, Guangdong (CN); Yinghao XIE, Foshan, Guangdong (CN); Aixia LI, Foshan, Guangdong (CN); Xuemei ZHANG, Foshan, Guangdong (CN); Changdong LI, Foshan, Guangdong (CN)

(73) Assignees: GUANGDONG BRUNP RECYCLING TECHNOLOGY CO., LTD., Foshan, Guangdong (CN); HUNAN BRUNP RECYCLING TECHNOLOGY CO., LTD., Changsha, Hunan (CN); HUNAN BRUNP VEHICLES RECYCLING CO., LTD., Changsha, Hunan (CN)

(21) Appl. No.: 18/265,386

(22) PCT Filed: Dec. 30, 2021
(86) PCT No.: PCT/CN2021/142949

§ 371 Date: Jun. 5, 2023

(30) Foreign Application Priority Data
Jun. 24, 2021 (CN) 202110705567.9

(51) Int. Cl. C01B 25/37; C01B 25/45; H01M 4/58; H01M 10/0525

(52) U.S. Cl. CPC C01B 25/375; C01B 25/45; H01M 4/5825; H01M 10/0525; B82Y 30/00

(57) ABSTRACT

A preparation method of nano-scaled iron phosphate, includes the steps of: adding a surfactant and a polymer microsphere to an iron salt solution to obtain a mixed liquid; adding a phosphate solution to the mixed liquid for reaction to obtain an iron phosphate slurry; performing solid-liquid separation after removing the polymer microsphere from the iron phosphate slurry, drying and calcining the obtained solid to obtain a nano-scaled iron phosphate.

### CROSS-REFERENCE TO RELATED APPLICATION

This application is a national stage filing under 35 U.S.C. § 371 of international application number PCT/CN2021/142949, filed Dec. 30, 2021, which claims priority to Chinese patent application No. 202110705567.9 filed Jun. 24, 2021. The contents of these applications are incorporated herein by reference in their entirety.

### TECHNICAL FIELD

The present disclosure belongs to the technical filed of the new energy material of lithium ion battery and specifically relates to a nano-scaled iron phosphate, and a preparation method and application thereof.

### BACKGROUND

The positive electrode material of lithium iron phosphate has the advantages of a wide range of raw materials, high safety factor, long service life, and low cost, and has attracted increasing attention and applications in the lithium battery industry. Iron phosphate is a precursor material for the synthesis of lithium iron phosphate, which largely determines the performance of the latter. Iron phosphates synthesized under different conditions are quite different, which leads to inconsistent performance of the positive electrode material of lithium iron phosphate.

Currently, iron salt and phosphoric acid or phosphate salt are often used in the industry to synthesize iron phosphate. The general synthesis method requires an adjustment of the pH value. A small number of alkaline substances such as ammonia and sodium hydroxide are added during this process, which causes the introduction of impurity cations. The introduction of impurity ions will cause the quality of the synthesized iron phosphate to below to a certain extent, thus affecting the electrochemical performance of lithium iron phosphate. Generally, the obtained iron phosphate particles are large with a small specific surface area, the electrochemical activity of the synthesized iron phosphate is not high, plus the theoretical capacity of the positive electrode material of lithium iron phosphate itself is limited, and its special two-dimensional ion channel makes it difficult for rapid charge transfer, which limits its electrochemical performance.

### SUMMARY

The present disclosure intends to at least solve one of the technical problems existing in the current technology. For this purpose, the present disclosure discloses a nano-scaled iron phosphate, and a preparation method and application thereof.

According to one aspect of the present disclosure, a preparation method of nano-scaled iron phosphate is disclosed, comprising the steps of:
S1: adding a surfactant and a polymer microsphere to an iron salt solution to obtain a mixed liquid;
S2: adding a phosphate solution to the mixed liquid for reaction to obtain an iron phosphate slurry;
S3: performing solid-liquid separation after removing the polymer microsphere from the iron phosphate slurry, drying and calcining the obtained solid to obtain a nano-scaled iron phosphate.

In some embodiments of the present disclosure, in step S1, the iron salt solution is at least one of an iron nitrate solution, an iron chloride solution, or an iron sulfate solution.

In some embodiments of the present disclosure, in step S1, the phosphate solution is at least one of ammonium phosphate or sodium phosphate.

In some embodiments of the present disclosure, in step S1, a molar ratio of iron in the iron salt solution to phosphorus in the phosphate solution is (0.8-1.2):1.

In some embodiments of the present disclosure, in step S1, the surfactant is at least one of sodium dodecylbenzenesulfonate, sodium dodecyl sulfate, or polyvinylpyrrolidone.

In some embodiments of the present disclosure, in step S1, a mass of the surfactant is 0.5-3.0% of a mass of iron salt in the iron salt solution.

In some embodiments of the present disclosure, the polymer microsphere is at least one of: a polystyrene microsphere, a polyethylene microsphere, or a polypropylene microsphere.

In some embodiments of the present disclosure, in step S1, the diameter of the polymer microsphere is 3.0-300 μm.

In some embodiments of the present disclosure, the polymer microsphere accounts for 3-10% of the total mass of the reactant material in step S2.

In some embodiments of the present disclosure, in step S2, the reaction is carried out at a stirring speed of 100-600 rpm; the temperature of the reaction is 90-130° C.

In some embodiments of the present disclosure, in step S3, the temperature of the drying is 50-100° C. the duration of the drying is 0.5-2.0 h.

In some embodiments of the present disclosure, in step S3, a temperature of the calcining is 200-400° C.; the duration of the calcining is 0.5-3 h.

The present disclosure also discloses nano-scaled iron phosphate prepared from the preparation method, a particle size of the nano-scaled iron phosphate being 10-100 nm.

The present disclosure also discloses the application of the nano-scaled iron phosphate in preparing a positive electrode material of a lithium ion battery, specifically, prepared by mixing and sintering the nano-scaled iron phosphate which serves as a raw material with a lithium source.

According to one preferred embodiment of the present disclosure, it at least has the following beneficial effects:
1. The preparation method of the present disclosure, by adding a surfactant and a polymer microsphere during the reaction synthesis process, on the one hand, dispersing iron phosphate through a macromolecular substance such as the surfactant, improves the dispersion of iron phosphate and controls the shape and size of iron phosphate; on the other hand, through the polymer microsphere, makes it hard for the obtained small crystal of iron phosphate to aggregate under the dispersive function of the polymer microsphere, avoids the phenomenon of particle agglomeration, and under strong stirring, enables the particle to collide with the polymer microsphere during its growth to obtain a nanometric product with a higher tap density.
2. The nano-scaled iron phosphate particles prepared by the present disclosure are used as the precursor material of the positive electrode material of the lithium ion battery. The particle size is the agglomeration phenomenon is scaring, the particle size distribution is relatively concentrated, the tap density is high, and the purity of the product is high. The prepared lithium iron phosphate has a smaller particle size, which is conducive to electrolyte infiltration, provides more rapid channels for lithium ion migration during charge and discharge, reduces the diffusion resistance of lithium ions, and improves the rate performance of the material.

### BRIEF DESCRIPTION OF DRAWINGS

Next, the present disclosure is further explained in combination with the drawings and embodiments, wherein:

FIG. 1 is a SEM diagram of the iron phosphate prepared by a conventional coprecipitation method.

FIG. 2 is a SEM diagram of the nano-scaled iron phosphate prepared in embodiment 1.

### DETAILED DESCRIPTION

Hereinafter, the concept of the present disclosure and the resulting technical effects will be described below clearly and completely in combination with the embodiments, so as to fully understand the purpose, features and effects of the present disclosure. Obviously, the described embodiments are only a part of the embodiments of the present disclosure, and not all embodiments. Based on the embodiments of the present disclosure, other embodiments obtained by those skilled in the art without involving any inventive effort all belong to the protection scope of the present disclosure.

### Embodiment 1

In the embodiment, an iron phosphate was prepared through the specific process of:
S1: selecting iron nitrate as a raw material to be dissolved in deionized water, filtering to obtain an iron salt solution for use, selecting ammonium phosphate as a raw material to be dissolved in deionized water to obtain a phosphate solution for use; wherein a molar ratio of iron in the iron salt solution to phosphorus in the phosphate solution was 0.8:1;
S2: opening the jacket of the reaction kettle to inlet and return water, adding the iron salt solution to the reaction kettle, and starting the reaction kettle to stir, always controlling the temperature of the reaction kettle at 90° C. and the stirring speed at 600 rpm;
S3: adding a sodium dodecylbenzenesulfonate with a 0.5% mass of the iron salt solution and a polystyrene microsphere with a diameter of 3.0 μm into the reaction kettle under constant stirring;
S4: slowly adding the phosphate solution to the reaction kettle for reaction; always controlling the temperature of the reaction kettle at 90° C. and the stirring speed at 600 rpm to obtain a white iron phosphate slurry, wherein the polystyrene microsphere accounted for 5% of the total mass of the reactant material.
S5: standing the iron phosphate slurry, performing solid-liquid separation after removing the suspended polystyrene microsphere, drying the obtained solid at a temperature of 50° C. for 2.0 h, and then calcining at a temperature of 200° C. for 3 h to obtain a nano-scaled iron phosphate.

A nano-scaled lithium iron phosphate was obtained by mixing and sintering the nano-scaled iron phosphate which served as a raw material with a lithium source.

### Embodiment 2

In the embodiment, an iron phosphate was prepared through the specific process of:
S1: selecting iron chloride as a raw material to be dissolved in deionized water, filtering to obtain an iron salt solution for use, selecting sodium phosphate as a raw material to be dissolved in deionized water to obtain a phosphate solution for use; wherein a molar ratio of iron in the iron salt solution to phosphorus in the phosphate solution was 1:1;
S2: opening the jacket of the reaction kettle to inlet and return water, adding the iron salt solution to the reaction kettle, and starting the reaction kettle to stir, always controlling the temperature of the reaction kettle at 100° C. and the stirring speed at 500 rpm;
S3: adding a sodium dodecyl sulfate with a 2.0% mass of the iron salt solution and a polyethylene microsphere with a diameter of 30 μm into the reaction kettle under constant stirring;
S4: slowly adding the phosphate solution to the reaction kettle for reaction; always controlling the temperature of the reaction kettle at 100° C. and the stirring speed at 500 rpm to obtain a white iron phosphate slurry, wherein the polyethylene microsphere accounted for 8% of the total mass of the reactant material.
S5: standing the iron phosphate slurry, performing solid-liquid separation after removing the suspended polyethylene microsphere, drying the obtained solid at a temperature of 75° C. for 1.0 h, and then calcining at a temperature of 300° C. for 2 h to obtain a nano-scaled iron phosphate.

A nano-scaled lithium iron phosphate was obtained by mixing and sintering the nano-scaled iron phosphate which served as a raw material with a lithium source.

### Embodiment 3

In the embodiment, an iron phosphate was prepared through the specific process of:
S1: selecting iron sulfate as a raw material to be dissolved in deionized water, filtering to obtain an iron salt solution for use, selecting a mixture of ammonium phosphate and sodium phosphate as a raw material to be dissolved in deionized water to obtain a phosphate solution for use; wherein a molar ratio of iron in the iron salt solution to phosphorus in the phosphate solution was 1.2:1;
S2: opening the jacket of the reaction kettle to inlet and return water, adding the iron salt solution to the reaction kettle, and starting the reaction kettle to stir, always controlling the temperature of the reaction kettle at 130° C. and the stirring speed at 100 rpm;
S3: adding a polyvinylpyrrolidone with a 3.0% mass of the iron salt solution and a polyethylene microsphere with a diameter of 100 μm into the reaction kettle under constant stirring;
S4: slowly adding the phosphate solution to the reaction kettle for reaction; always controlling the temperature of the reaction kettle at 130° C. and the stirring speed at 100 rpm to obtain a white iron phosphate slurry, wherein the polyethylene microsphere accounted for 10% of the total mass of the reactant material.
S5: standing the iron phosphate slurry, performing solid-liquid separation after removing the suspended polypropylene microsphere, drying the obtained solid at a temperature of 100° C. for 0.5 h, and then calcining at a temperature of 400° C. for 0.5 h to obtain a nano-scaled iron phosphate.

A nano-scaled lithium iron phosphate was obtained by mixing and sintering the nano-scaled iron phosphate which served as a raw material with a lithium source.

### Embodiment 4

In the embodiment, an iron phosphate was prepared through the specific process of:
S1: selecting iron nitrate as a raw material to be dissolved in deionized water, filtering to obtain an iron salt solution for use, selecting sodium phosphate as a raw material to be dissolved in deionized water to obtain a phosphate solution for use; wherein a molar ratio of iron in the iron salt solution to phosphorus in the phosphate solution was 1.1:1;
S2: opening the jacket of the reaction kettle to inlet and return water, adding the iron salt solution to the reaction kettle, and start the reaction kettle to stir, always controlling the temperature of the reaction kettle at 110° C. and the stirring speed at 300 rpm;
S3: adding a sodium dodecyl sulfate with a 1.0% mass of the iron salt solution and a polyethylene microsphere with a diameter of 200μm into the reaction kettle under constant stirring;
S4: slowly adding a phosphate solution to the reaction kettle for reaction; always controlling the temperature of the reaction kettle at 110° C. and the stirring speed at 300 rpm to obtain a white iron phosphate slurry, wherein the polyethylene microsphere accounted for 3% of the total mass of the reactant material.
S5: standing the iron phosphate slurry, performing solid-liquid separation after removing the suspended polyethylene microsphere, drying the obtained solid at a temperature of 85° C. for 1.0 h, and then calcining at a temperature of 250° C. for 2.5 h to obtain a nano-scaled iron phosphate.

A nano-scaled lithium iron phosphate was obtained by mixing and sintering the nano-scaled iron phosphate which served as a raw material with a lithium source.

### Embodiment 5

In the embodiment, an iron phosphate was prepared through the specific process of:
S1: selecting a mixed salt of iron nitrate and iron chloride as a raw material to be dissolved in deionized water, filtering to obtain an iron salt solution for use, selecting sodium phosphate as a raw material to be dissolved in deionized water to obtain a phosphate solution for use; wherein a molar ratio of iron in the iron salt solution to phosphorus in the phosphate solution was 0.9:1;
S2: opening the jacket of the reaction kettle to inlet and return water, adding the iron salt solution to the reaction kettle, and starting the reaction kettle to stir, always controlling the temperature of the reaction kettle at 120° C. and the stirring speed at 200 rpm;
S3: adding a sodium dodecyl sulfate with a 2.0% mass of the iron salt solution and a polyethylene microsphere with a diameter of 150 μm into the reaction kettle under constant stirring;
S4: slowly adding a phosphate solution to the reaction kettle for reaction; always controlling the temperature of the reaction kettle at 120° C. and the stirring speed at 200 rpm to obtain a white iron phosphate slurry, wherein the polyethylene microsphere accounted for 6% of the total mass of the reactant material.
S5: standing the iron phosphate slurry, performing solid-liquid separation after removing the suspended polyethylene microsphere, drying the obtained solid at a temperature of 75° C. for 1.0 h, and then calcining at a temperature of 300° C. for 2 h to obtain a nano-scaled iron phosphate.

A nano-scaled lithium iron phosphate was obtained by mixing and sintering the nano-scaled iron phosphate which served as a raw material with a lithium source.

### Embodiment 6

In the embodiment, an iron phosphate was prepared through the specific process of:
S1: selecting a mixed salt of iron chloride and iron sulfate as a raw material to be dissolved in deionized water, filtering to obtain an iron salt solution for use, selecting ammonium phosphate as a raw material to be dissolved in deionized water to obtain a phosphate solution for use; wherein a molar ratio of iron in the iron salt solution to phosphorus in the phosphate solution was 1.05:1;
S2: opening the jacket of the reaction kettle to inlet and return water, adding the iron salt solution to the reaction kettle, and starting the reaction kettle to stir, always controlling the temperature of the reaction kettle at 95° C. and the stirring speed at 550 rpm;
S3: adding a sodium dodecylbenzenesulfonate with a 2.5% mass of the iron salt solution and a polystyrene microsphere with a diameter of 125μm into the reaction kettle under constant stirring;
S4: slowly adding a phosphate solution to the reaction kettle for reaction; always controlling the temperature of the reaction kettle at 95° C. and the stirring speed at 550 rpm to obtain a white iron phosphate slurry, wherein the polystyrene microsphere accounted for 5% of the total mass of the reactant material.
S5: standing the iron phosphate slurry, performing solid-liquid separation after removing the suspended polystyrene microsphere, drying the obtained solid at a temperature of 50° C. for 2.0 h, and then calcining at a temperature of 200° C. for 3 h to obtain a nano-scaled iron phosphate.

A nano-scaled lithium iron phosphate was obtained by mixing and sintering the nano-scaled iron phosphate which served as a raw material with a lithium source.

### Embodiment 7

In the embodiment, an iron phosphate was prepared through the specific process of:
S1: selecting a mixed salt of iron nitrate and iron sulfate as a raw material to be dissolved in deionized water, filtering to obtain an iron salt solution for use, selecting ammonium phosphate as a raw material to be dissolved in deionized water to obtain a phosphate solution for use; wherein a molar ratio of iron in the iron salt solution to phosphorus in the phosphate solution was 1.15:1;
S2: opening the jacket of the reaction kettle to inlet and return water, adding the iron salt solution to the reaction kettle, and starting the reaction kettle to stir, always controlling the temperature of the reaction kettle at 105° C. and the stirring speed at 450 rpm;
S3: adding a polyvinylpyrrolidone with a 1.5% mass of the iron salt solution and a polystyrene microsphere with a diameter of 50μm into the reaction kettle under constant stirring;
S4: slowly adding a phosphate solution to the reaction kettle for reaction; always controlling the temperature of the reaction kettle at 105° C. and the stirring speed at 450 rpm to obtain a white iron phosphate slurry, wherein the polystyrene microsphere accounted for 7% of the total mass of the reactant material.
S5: standing the iron phosphate slurry, perform solid-liquid separation after removing the suspended polystyrene microsphere, drying the obtained solid at a temperature of 50° C. for 2.0 h, and then calcining at a temperature of 200° C. for 3 h to obtain a nano-scaled iron phosphate.

A nano-scaled lithium iron phosphate was obtained by mixing and sintering the nano-scaled iron phosphate which served as a raw material with a lithium source.

Table 1 is the results of the parametric test of the iron phosphate products prepared by Embodiments 1-7 and the conventional coprecipitation method.

TABLE 1

| | Test item | | | | | | | |
|---|---|---|---|---|---|---|---|---|
| | | | | | | | | Conventional |
| | Embodi- | Embodi- | Embodi- | Embodi- | Embodi- | Embodi- | Embodi- | coprecipitation |
| | ment 1 | ment 2 | ment 3 | ment 4 | ment 5 | ment 6 | ment 7 | method |
| Particle | 50-70 | 30-50 | 40-50 | 20-30 | 20-40 | 50-60 | 70-90 | 80-300 |
| size (nm) | | | | | | | | |
| Tap | 0.85 | 0.82 | 0.86 | 0.82 | 0.83 | 0.85 | 0.84 | 0.72-0.80 |
| density (g/cm³) | | | | | | | | |
| Agglomeration | None | None | None | None | None | None | None | Present |
| condition | | | | | | | | |

As can be seen from Table 1, the particle sizes of Embodiments 1-7 are all in the range of 10-100 nm, with a tap density higher than that of the conventional coprecipitation method, a smaller average particle size, a more even particle size distribution, and less agglomeration phenomenon.

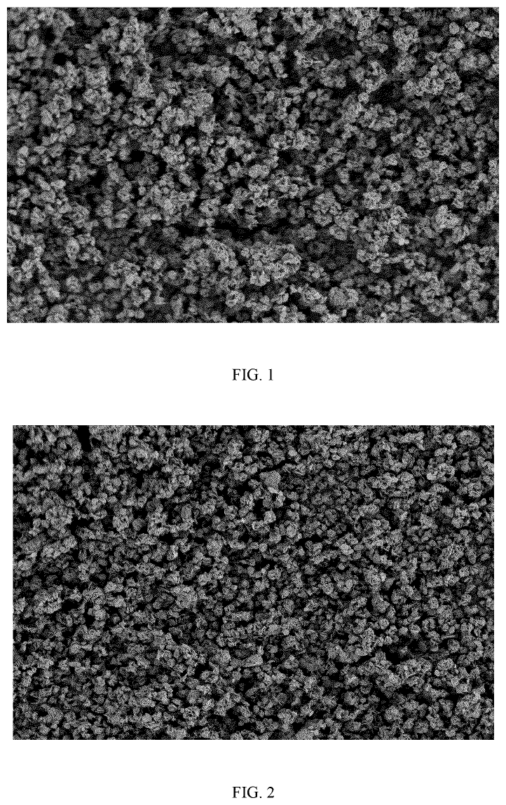

FIG. 1 is a SEM diagram of the iron phosphate prepared by a conventional coprecipitation method. FIG. 2 is a SEM diagram of the nano-scaled iron phosphate prepared in embodiment 1. As can be seen from the comparison between FIG. 1 and FIG. 2, the iron phosphate particles prepared by the conventional coprecipitation method in FIG. 1 have a larger particle size and more serious agglomeration, and the iron phosphate particles in FIG. 2 have uniform and fine particle sizes without obvious agglomeration.

The present disclosure is described in detail above in combination the Drawings. However, the present disclosure is not limited to the above embodiments. Within the knowledge scope of those skilled in the art, various modifications can be made without departing from the scope of the present disclosure. In addition, in the case of no conflict, the embodiments of the present disclosure and features in the embodiments can be combined with each other.

1. A preparation method of nano-scaled iron phosphate, comprising the steps of:
S1: adding an iron salt solution to a reaction kettle, and starting the reaction kettle to stir, adding a surfactant and a polymer microsphere to the iron salt solution to obtain a mixed liquid;
S2: slowly adding a phosphate solution to the mixed liquid in the reaction kettle for reaction to obtain an iron phosphate slurry;
S3: standing the iron phosphate slurry, performing solid-liquid separation after removing the suspended polymer microsphere, drying and calcining the obtained solid to obtain a nano-scaled iron phosphate;
wherein, in step S1, the polymer microsphere is at least one of: a polystyrene microsphere, a polyethylene microsphere, or a polypropylene microsphere; and a diameter of the polymer microsphere is 3.0-300 μm.

2. The preparation method of claim 1, wherein, in step S1, the iron salt solution is at least one of an iron nitrate solution, an iron chloride solution, or an iron sulfate solution.

3. The preparation method of claim 1, wherein, in step S1, the phosphate solution is at least one of ammonium phosphate or sodium phosphate.

4. The preparation method of claim 1, wherein, in step S1, a molar ratio of iron in the iron salt solution to phosphorus in the phosphate solution is (0.8-1.2):1.

5. The preparation method of claim 1, wherein, in step S1, the surfactant is at least one of sodium dodecylbenzenesulfonate, sodium dodecyl sulfate, or polyvinylpyrrolidone.

6. (canceled)

7. The preparation method of claim 1, wherein the polymer microsphere accounts for 3-10% of a total mass of the reactant material in step S2.

8. The preparation method of claim 1, wherein, in step S2, the reaction is carried out at a stirring speed of 100-600 rpm; a temperature of the reaction is 90-130° C.

9-20. (canceled)
